(19) United States
(12) Patent Application Publication
(10) Pub. No.: US 2008/0306804 A1
(43) Pub. Date: Dec. 11, 2008

(54) SYSTEMS FOR SCHEDULING MARKETING CAMPAIGNS IN PUBLIC PLACES IN ORDER TO ENABLE MEASUREMENT AND OPTIMIZATION OF AUDIENCE RESPONSE

(76) Inventors: Thomas C. Opdycke, Bellevue, WA (US); Wan-Chung W. Wu, Bellevue, WA (US); Jeremy York, Bothell, WA (US); Paul Dixon, Seattle, WA (US)

Correspondence Address: PERKINS COIE LLP;PATENT-SEA, P.O. BOX 1247, SEATTLE, WA, 98111-1247, US

(21) Appl. No.: 12/134,992

(22) Filed: Jun. 6, 2008

Related U.S. Application Data
(60) Provisional application No. 60/942,339, filed on Jun. 6, 2007.

(51) Int. Cl. G06Q 10/00

(52) U.S. Cl. 705/8

(57) ABSTRACT

A system is described for determining how to execute a media campaign (e.g., an advertising campaign) in out-of-home environments (e.g., retail stores or other public places), in such a manner as to enable analysis of the impact of the campaign upon audience behavior, and some of the aspects of audience behavior (recollection of recent exposure, impact of repeat exposures over time) that can be incorporated into subsequent analysis; this can then extend into alterations to the campaign scheduling to optimize business metrics and/or to gain additional, richer information about audience behavior. Media content can be rendered on one or more devices, such as monitors, point of sale systems, and so forth. The media content can include advertisements, such as advertisements having images, video, audio, and multimedia content. Various business constraints and statistical experimental constraints can be satisfied when generating a schedule.

### CROSS-REFERENCE TO RELATED APPLICATION(S)

This application claims the benefit of U.S. Provisional Patent Application No. 60/942,339 filed Jun. 6, 2007 (entitled “SYSTEMS FOR SCHEDULING MARKETING CAMPAIGNS IN PUBLIC PLACES IN ORDER TO ENABLE MEASUREMENT AND OPTIMIZATION OF AUDIENCE RESPONSE”), which application is incorporated herein in its entirety by reference.

### BACKGROUND

Many purchase decisions are made while customers are shopping in a store. To influence these decisions, manufacturers and retailers make effective use of product packaging and printed point-of-purchase advertising. The use of media devices—video displays, speakers, etc.—in stores, malls, and other public spaces promises to revolutionize marketing by providing dynamic, captivating content. Retailers, network operators and advertisers would like to measure and optimize the benefits of such a system.

Unfortunately, audience response data and records of content played on media devices often source from two or more disparate systems that have no interactions. Even when the systems are integrated, it may not be easy to integrate the different types of data. For example, a customer may be intrigued by a marketing campaign displayed on a flat-screen display in a retail store environment, resulting in them purchasing the promoted product. The purchase transaction record will typically be recorded through retail store's point-of-sale (POS) network, while the marketing campaign is broadcast via a separate digital signage network. Without methods to correlate these sources of data, traditional marketing analysis can only relying on analyzing the pure behavior response data (such as changes in sales over time) as their performance benchmark. The result is an aggregated, simplified analysis which is unable to determine how other factors impact campaigns performance.

The traditional way of evaluating a marketing campaign via mass media such as TV, radio or newspaper advertising is to design a experiment, in which individuals in certain times and places are exposed to the campaign, while other individuals (in different locations and/or at different times) are not. Both for ease of deploying the campaign, and for subsequent data analyses, these experiments are typically very simple. For example, in one market (geographical area), the campaign is deployed, while in other markets, it is not. These simple designs run into substantial problems when audience behavior differs between the markets for reasons other than the marketing campaign. For example, if a competitor is launching a competing product in one market but not the other, it becomes impossible to determine whether differences in sales for the two markets are caused by the marketing campaign or by the competitor's activities.

The simple experiments described above are typically done because conventional advertising channels (billboards, cardboard displays and floor stickers in stores, et cetera) are expensive to deploy, and significant cost savings are achieved by doing things in the same fashion in as many places as possible. The cost, and physical attributes of these conventional out-of-home advertising channels rules out more complex experiments that would be able to more reliably assess the impact of the marketing campaign as well as determine how response to the campaign depends on other factors (such as time of day, time of year, region, et cetera). Systems of media devices for delivering advertising content to public places, provide much greater flexibility; the typical simple experiments fail to exploit this capability.

### BRIEF DESCRIPTION OF THE DRAWINGS

FIG. 1 is a block diagram illustrating a system for generating a schedule for one or more campaigns, informing a signage network of the schedules, monitoring execution of that schedule along with audience behavior, analyzing relations between the campaign and the audience behavior, and using that analysis to modify the schedule.

FIG. 2 is a flow diagram illustrating a general approach to specifying constraints and objectives for use in developing a schedule for one or more campaigns.

FIG. 3 is a high level flow diagram illustrating an application of the scheduling approach and how interactions with a network of media devices are handled.

FIG. 3a is a block diagram illustrating a sample representation of schedule constructed based on instructions created from permutations of various potential factors related to the nature of scheduling.

FIG. 3b is a block diagram illustrating possible construction of a schedule from combining playlist-based and instruction-based approaches discussed in this patent.

FIG. 3c is a flow diagram illustrating an embodiment of a system for communicating schedules to a network of media devices and obtaining execution data in return.

FIG. 3d is a block diagram illustrating an embodiment of a system for monitoring execution and compliance with a campaign schedule, and modifying the schedule when necessary.

FIG. 3e is a flow diagram illustrating an example of how an application programming interface can be provided for enabling automatic transfer of license-protected schedule recommendations.

FIG. 4 is a chart illustrating a type of data transformation that can be applied to dark periods (an interval of time in which a campaign does not display on one or more media devices in a location) in order to correct for a time lag between when they are exposed to the campaign and when they engage in the monitored audience behavior.

FIG. 5 is a chart illustrating a type of data transformation that can be applied to long periods of the use of a campaign, to allow for a build-up of effect after repeated exposures, followed by a decline in effect as the campaign becomes old.

FIG. 6 is a chart illustrating types of data transformations that can be applied to the same type of effects considered in FIG. 5, but decomposing the build-up effect.

### DETAILED DESCRIPTION

A system is described for determining how to execute a media campaign (e.g., an advertising campaign) in out-of-home environments (e.g., retail stores or other public places), in such a manner as to enable analysis of the impact of the campaign upon audience behavior, and some of the aspects of audience behavior (recollection of recent exposure, impact of repeat exposures over time) that can be incorporated into subsequent analysis; this can then extend into alterations to the campaign scheduling in order to optimize business metrics and/or to gain additional, richer information about audience behavior. Media content can be rendered on one or more devices, such as monitors, point of sale systems, and so forth. The media content can include advertisements, such as advertisements having images, video, audio, and multimedia content.

The term media device will be used to describe devices which provide sensory input—examples include, but are not limited to, signs (flat panel displays, LCDs, projection devices, etc.), audio devices (speakers, headphones, etc.), interactive kiosks, devices which dispense an aroma, and so on. A media device could also be a means of communicating content to a mobile computing device or portable phone held by the audience member. Marketing and other content displayed or played on media devices in public places will be referred to as campaigns. The plan by which campaigns are programmed on media devices will be referred to as a schedule. A schedule can include factors such as which locations or media devices will display or play the campaign, how often and what times of day or days of week the campaign will play, etc. The schedule can take a variety of forms, such as “round robin” (play each available campaign in sequence, then repeat), random (choose randomly from the available campaigns), “play list” (specified sequence of campaigns). A specific time and place when a particular campaign was played or displayed will be referred to as a media event The people who are exposed to these campaigns are referred to as the audience. Measurable actions taken by the audience are referred to as audience behavior events; information about many audience behavior events will be referred to collectively as audience behavior. Audience behavior events can include but are not limited to: entry into a facility or store (perhaps as recorded by a security device, or as detected by a video camera with subsequent automated or manual processing), entry into a particular section of a store, amount of time spent in the store or a section of the store, taking an item off of the shelf and placing it into a shopping cart or basket (perhaps detected with a radio frequency identifier (RFID) tag on the product and a system for tracking the location of those RFID tags), whether the customer looks at a sign (perhaps detected by a video camera located on or near the sign, with subsequent automated or manual processing), data from a customer session on an interactive kiosk, and the purchase of one or more products (data recorded may include the product identifier, the price paid, the quantity purchased, the store identifier, the cash register identifier, a customer identifier, etc.).

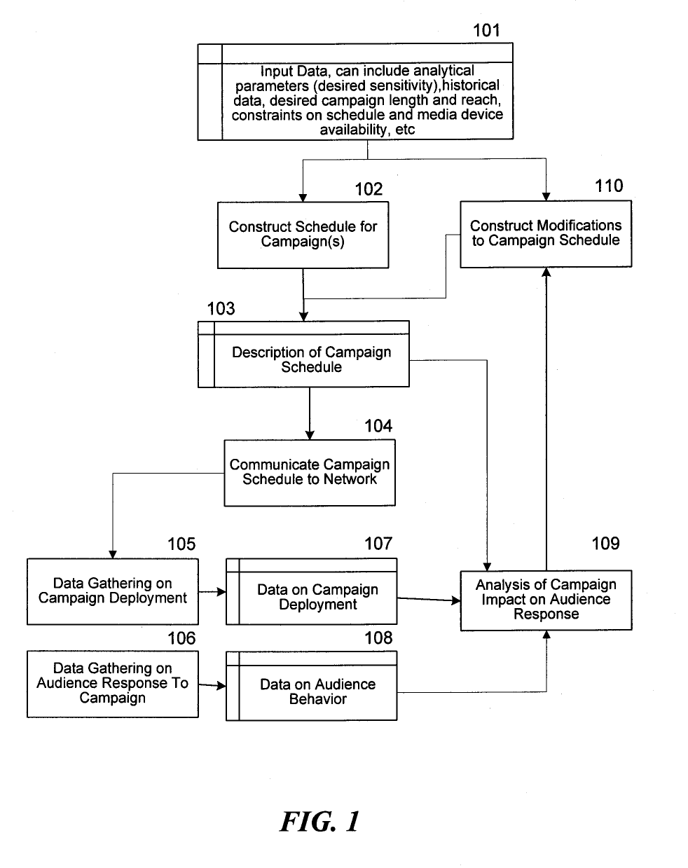

FIG. 1, which is a block diagram illustrating a system in some embodiments for how such a scheduling system is designed, executed, and acted upon, provides an illustration of such a system.

A variety of parameters and initial data sources 101 can be provided. This data can include historical data on audience behavior, similar campaigns, etc; analytical parameters; the days, times, and frequency with which the campaign should be aired; scheduling constraints; data on the state of the network of media devices (which ones are in service and able to show or play the campaign, etc), and so on. Various “business constraints” can be imposed on schedules. Based on this input, a schedule for one or more campaigns 103 can be produced by the invention. This campaign schedule has to be put in place on the network of media devices in some fashion, 104. Meanwhile, data 107 can be gathered on whether, when and where the media events occur (another option is to trust that the desired campaign schedule 103 was indeed deployed; but depending upon the reliability and predictability of the network of media devices and the devices themselves, having some form of data on what the media devices actually did is preferable); also, data on audience behavior can be gathered. In either case, as discussed in patent application Ser. No. 11/619,506, (which is incorporated herein by reference in its entirety) the data on media events and/or audience behavior could be at a detailed level or at an aggregated level. Analysis 109 upon one or both of these data sources may yield results interesting and useful in their own right. Optionally, the results of this analysis 109 (not enough people of the desired demographic are being reached, one campaign is preferable to another at a certain time of day, making adjustments because the initial schedule was not adhered to, etc) can be used 110 to produce a new schedule, or modifications to the current schedule. The new or modified schedule may be intended to improve the audience behavior in response to the campaign—a campaign optimization—or to improve the gathering of data needed for subsequent analysis, or to optimize other business needs (e.g. targeting a desired demographics).

In an embodiment, a framework 106 for an automated data feed is put in place. This framework accepts data from one or more businesses or other entities such as retail stores, shopping malls, sports facilities, and other venues. The data provided describes audience behavior with at least some information about the times and places that the behavior occurred. The audience behavior data may be aggregated by time period, e.g., foot traffic per hour, or it may list individual events, e.g., at this time a customer purchased this item. The framework also accepts data 105 from a system of media devices, providing information on what media campaigns were delivered or intended to be delivered. Note that the methods of this invention can be implemented as part of an integrated system that includes the network of media devices and/or the system(s) that monitor or record audience behavior.

In an embodiment, the audience behavior data 108 and the media event data 107 described above are manually obtained, such as by querying database systems or processing logs from cash registers, sign systems, monitoring devices, etc. The resulting data is then manipulated according to the methods described in this document.

Numerous embodiments lie between the two described above, depending on which portions of the data gathering and processing are automated (whether scheduled or on-demand) or performed manually.

### Construction of a Campaign Schedule

Various business constraints may exist for the scheduling of one or more campaigns. These can include, but are not limited to: restrictions on what can be played before or after a campaign (don't play ads for competing products back to back), restrictions on the maximum number of plays or duration of plays in a location, maximum and/or minimum limits on the number of campaigns that can be shown on a media device, other types of content (public service and informational content) that needs to be played on the media devices with some frequency.

In addition, it is desired to impose patterns on where and when a campaign is displayed, in order to be able to gather data on audience behavior both with and without the stimulus of the campaign, with all other factors being mostly equal. For example, if a campaign is not shown at all in one location on a Thursday afternoon, audience behavior data for that place and time might used to compare to other times in the same location (and/or other locations at the same time) when the campaign was present, and thus gain information about the effect of the campaign on audience behavior. Statistical Experimental Design can be used to to design experiments, where different “factors” or other constraints (e.g. campaign, time of day, location) are rotated among the various subjects in the experiment to gain a detailed understanding of how those factors impact the response (e.g. sales, store traffic, count of kiosk interactions). For example, in agricultural field trials, different combinations of fertilizer and herbicide may be applied to different sections of land, which have various characteristics of drainage and sunlight. Other examples of such experiments are in industrial process control (which adhesive, at which temperature and with what level of force applied, produces the best seal) and clinical trials (patients are exposed to a sequence of blood pressure medications over a period of months to determine which medication provides the best result). Other fields, such as machine learning, approach this design problem in a slightly different way, choosing to have a flexible approach that still allows for gathering of actionable data while also allowing for changes in strategy as the study progresses, as opposed to the statistical approach which is optimized for maximum extraction of information but allows for few or no changes along the way.

Various scheduling approaches can be used to evaluate different variations of stimuli to the audience and their subsequent behavior. These can include not showing the campaign, showing the campaign infrequently, showing the campaign frequently or constantly, showing the campaign in conjunction with some different content, and so on. The schedule can involve rotating between multiple such states for a given campaign.

Planned application of a statistical, machine learning, or other data analytic approach can yield superior results with a careful design of when and where the audience will be exposed to which stimuli. The methodology applied may require specification of certain parameters to start. For example, in the case of statistical experimental design, desired sensitivity—power and significance level—are typically specified in advance in order to decide upon the length of the study and the depth that will be considered in the analysis. Alternately, the length and size of the data gathering may be determined by business or availability reasons. In the case of machine learning, the time devoted to training may be specified, or the weight which controls the speed of decay of the influence of past data. The resulting designs—calling for various campaigns to be displayed or not at different times and places during the course of the measurement activity—can get quite complex. While it is possible to both determine these designs and deploy them purely manually, this becomes expensive and burdensome.

As an example, a schedule for a single campaign might be set in place such that the campaign plays for 16 out of 24 hours each day on the media devices in each location. For a particular location, a statistical experimental design may dictate that the 8 hour outages be uniformly distributed across days of the week and times of the day. Meanwhile, no two locations should have the exact same pattern. The mathematical requirement may be that a design matrix constructed for a linear model (one row per place/time, one column per relevant factor—e.g. campaign activity, place, time, weather, additional columns to reflect interactions between factors) will be invertible.

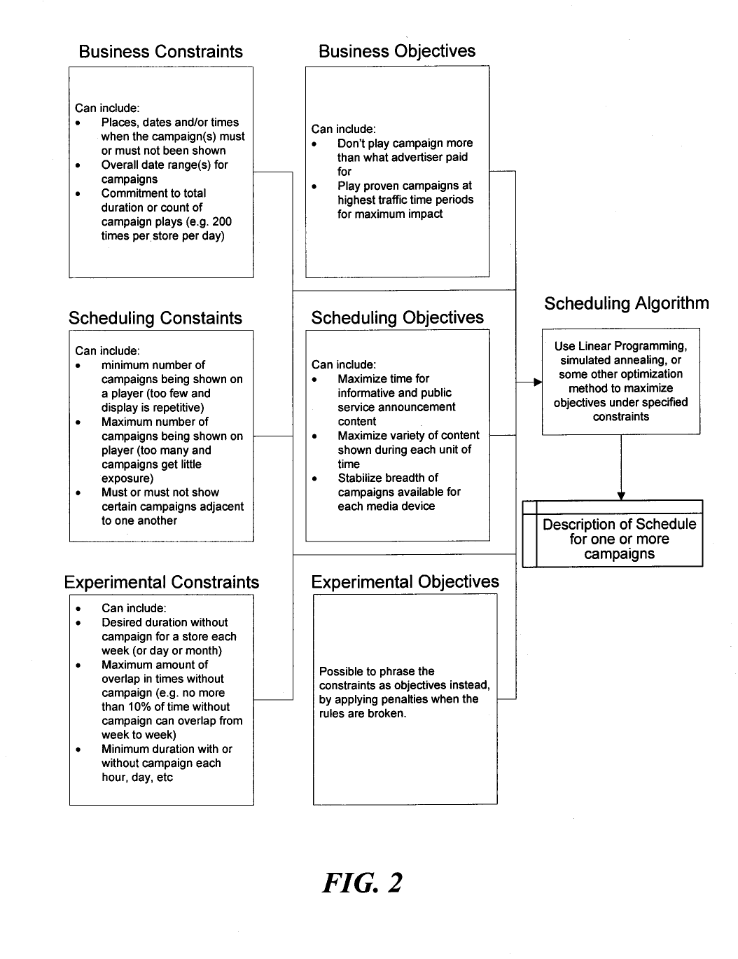

One aspect of the invention is how to achieve a pattern of when and where to display a campaign, such that the baseline data (data on how the audience behaves when not exposed to the campaign) made available is sufficient to support the desired analysis. An example of the data flow that can go into such a system is shown in FIG. 2.

A distinction can be drawn between Constraints (things that must be satisfied) and Objectives (things that we would like to satisfy). For example, providing a certain amount of exposure may be a constraint (perhaps because of contractual obligations to the advertiser); while achieving a certain level of baseline time without the campaign on Mondays in a particular store may be an objective, something that can be compromised.

One type of constraint that is distinctive to this area of application is the number of campaigns made available for play. Consider a network of media devices, in which it is desirable to evaluate every single campaign that will be playing on the media devices. Furthermore, in this example, there may be no historical data available to use to help calibrate the evaluation of impact of the campaign on audience behavior. This may because the audience behavior being considered is purchase of a new product, or shopping behavior in a new chain of stores that has just opened. In such a case, it is useful to gather baseline data—audience behavior data without the influence of the campaigns—in the manner described above. However, without carefully assembling a schedule for the campaigns in questions, there may be times and places where there are an unacceptably low number of campaigns available to play on a particular media device. Therefore, in addition to satisfying the requirements of the analytical approach being applied, it is also important to ensure that there is sufficient content on each player.

Some embodiments specify a single objective function that evaluates a schedule, combining terms for every desired objective into a single number. In the example above, the objective of ensuring an adequate number of campaigns for every play at every time could be regarded as such an objective, and a numerical expression of this objective can be expressed (for example, the percentage of time periods with adequate coverage) and used as a contribution to the overall objective function. This objective function can then be maximized across the set of all possible schedules that satisfy the constraints (if any), and the resulting solution will be used. Alternately, the objective function could focus on other aspects, while ensuring an adequate range of campaigns for every media device could be considered as a constraint.

Even in simpler cases, which don't involve multiple campaigns or hard (inviolable) or soft (open to compromise) constraints on the number of campaigns available for each media device, there can still be sufficient complexity to the other constraints and objectives to motivate application of the invention. Additionally, it is often desirable to take learnings from early data (e.g. one particular campaign is not very effective, or that another campaign is most effective at a certain time of day) and apply that back to the scheduling. This can be to avoid learning more about cases that are not interesting (just how much worse a particular campaign is than the alternatives), or to maximize some other business measure (emphasize use of a campaign at the time of day when it's proven to drive the most sales). In fact, the expected sales (or impressions, or customer interactions with a kiosk, etc) could become the primary objective function for evaluating a schedule.

A variety of approaches can be applied to this optimization problem of determining a schedule which maximizes the objectives while satisfying the constraints, including brute force, Monte Carlo, linear programming, simulated annealing, genetic algorithms, et cetera. As one embodiment of the invention, brute force involves determining every possible schedule, and evaluating each with respect to the constraints and objectives. The schedule which achieves the best performance on the objectives while satisfying the constraint is the outcome. Monte Carlo approximates the brute force approach, by randomly generating a wide variety of possible schedules, and evaluating them with respect to the constraints and objectives, choosing the one which satisfies the constraints while meeting the objectives. One option is to include one or more of the constraints in the random generation of schedules, if feasible, so that all randomly generated schedules abide by the included constraints. A linear programming approach could be implemented as follows. Represent the schedule as a vector x with one dimension for every time and place in question. Express constraints such as minimum playtime c in a certain store in a certain week, by constructing a vector a which has a 1 for all dimensions matching that store and week and 0 elsewhere, and then providing a constraint of a^{T}x>=c. The objective function is similarly a linear function of x. Linear programming then provides an algorithmic solution to finding the maximum of the objective function subject to the constraint.

Some types of constraints or objectives can be difficult to express as linear functions of x. In another embodiment of the invention, the approach of simulated annealing can be applied to circumvent those difficulties. An initial proposal of the schedule x is proposed. A variety of small changes to the schedule are considered, and one of them is chosen with a certain probability. The probability of each possible change is a function of whether It lowers the objective function (less probable) or raises it (more probable), as well as being a function of a temperature parameter. Initially, the temperature parameter is set such that there is very little difference in probability between any of the options. As the algorithm progresses, the temperature “cools” according to the schedule, making the algorithm much less likely to accept a reduction in the objective function.

These embodiments can be applied to scheduling for a single campaign, for multiple campaigns simultaneously, or for all of the programming on the network of media devices.

In another embodiment, the invention may be used by the advertiser or an agent for the advertiser, who is considering purchasing advertising time on multiple networks of media devices. In this case, the constraints may be a matter of availability of the media devices on the various networks (they may already be committed to showing different campaigns at the desired times), the budget available to spend on buying the advertising time, as well as the other types of factors already discussed. In such a case, the invention could be applied independently to each network to determine a schedule for each one. Alternately, the experimental design may be viewed as going across the different networks, taking the network into account as a factor in the model, and the optimization effort becomes a matter of simultaneously determining schedules across the network that satisfies budgeting constraints while simultaneously optimizing for appropriate objectives.

The constraints and objectives in such a scenario may look very different from those given in the example that was centered around the network operator. The constraints may include the total budget, buying constraints applied by the networks (e.g. a network may force the advertiser to buy at least some certain quantity), time frame (e.g., 50% of spending must overlap with a major television advertising campaign), etc. The objectives can include factors such as minimizing total cost, buying higher quality exposure time, the degree to which the ad time will reach out to a desired demographic, and the projected impact on audience behavior.

As another example of an embodiment of the invention, consider the application of a Machine Learning approach to scheduling, as applied to a case where there are multiple competing campaigns available, and the goal is to determine which campaign provides the best performance while also maximize the desired audience behavior response. In machine learning, this problem is often referred as a “one-armed bandit” based on the following thought experiment. Given a pool of money and access to 10 slot machines with different, unknown odds, the goal is to maximize the return. Here, the choice of campaign content, and when and where to schedule it, corresponds to the slot machine.

The standard machine learning approach can be summarized as follows. First, determine a random schedule, which allocates different campaign content across the different media devices and times randomly. Then, gather data on the audience behavior attributed to the different campaigns. Compute a set of probabilities for each campaign in each setting (by setting, we mean a particular location on a particular day and/or time of day), based upon the audience behavior observed in similar settings (e.g. the same location on a comparable day and/or same time of day). The better the audience behavior, the higher the probability.

The machine learning approach can make very localized decisions - the choice of which campaign will play at a particular time and place typically is not dependent on the choices made for other times and places. However, many of our constraints and objectives apply to the overall schedule. One embodiment of the invention is to apply the Monte Carlo approach to the scheduling instructions produced by the machine learning approach. Use the machine learning approach to generate multiple alternate schedules according to the probability distribution computed from past behavior. Evaluate each of the alternatives to determine if it satisfies the constraints, and to determine the value of the objective function. Select the schedule that provides the best performance, and implement it.

### Communication of the Schedule to a Network of Media Devices

Interacting with a system or organization to take a schedule of the kind described above and put it into place presents a different set of challenges. Some embodiments of the invention address those challenges by providing an automated exchange of instructions and data between the network of media devices and the system responsible for creating an experimental design under a set of constraints. Alternatively, the functions could reside with the same computer system.

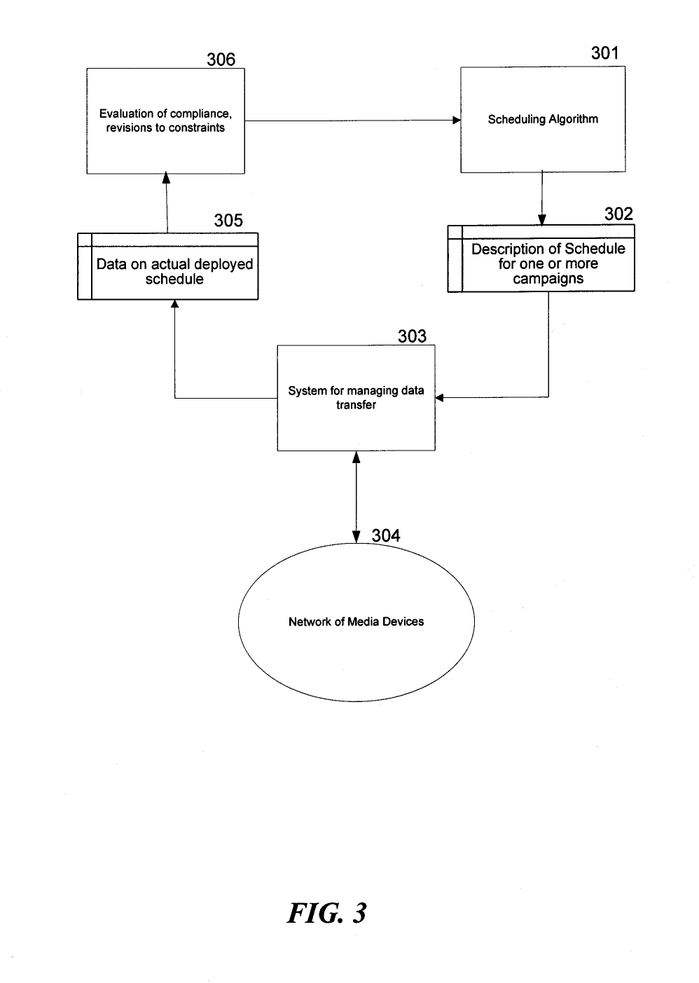

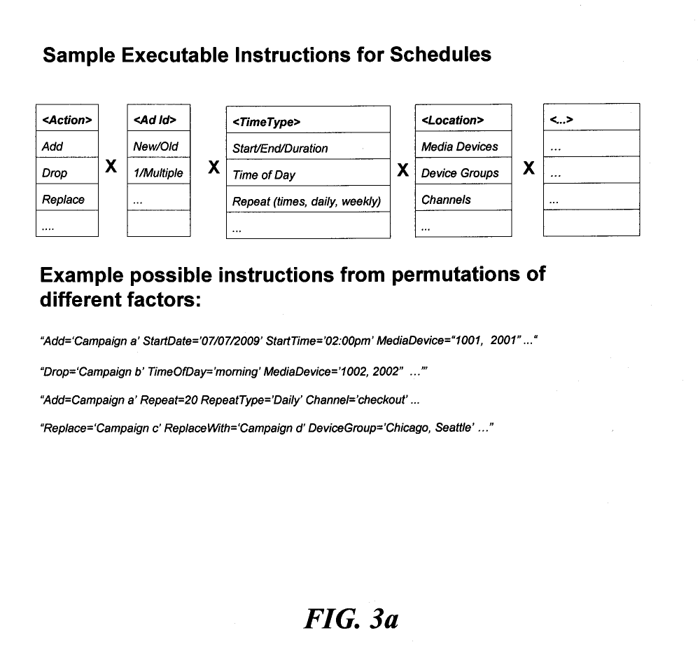

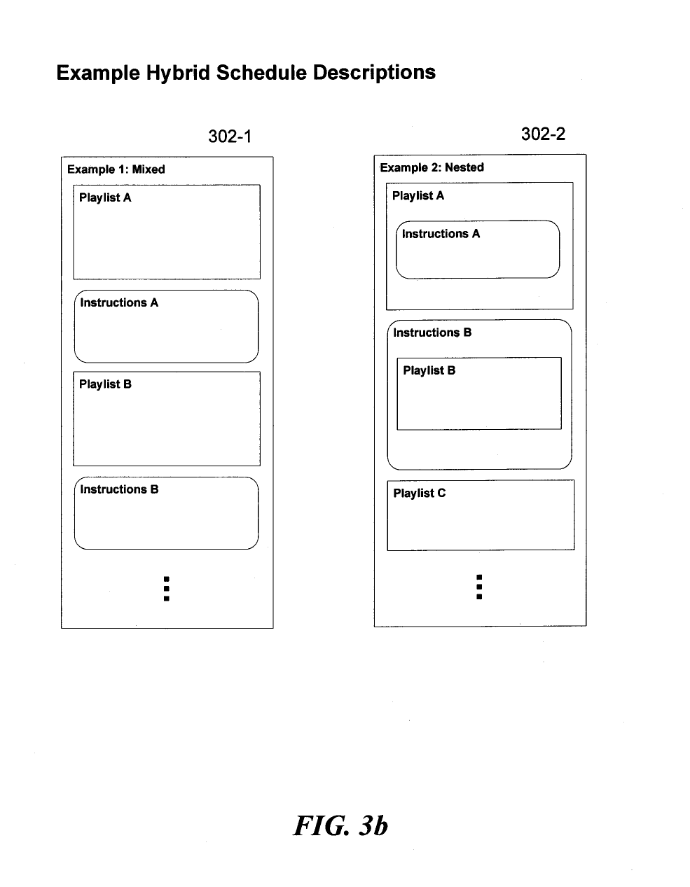

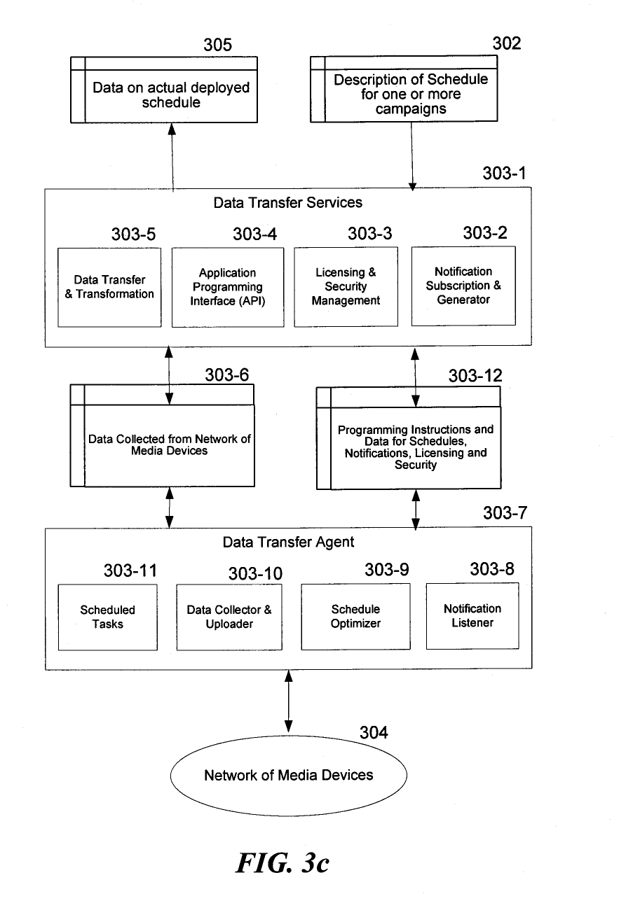

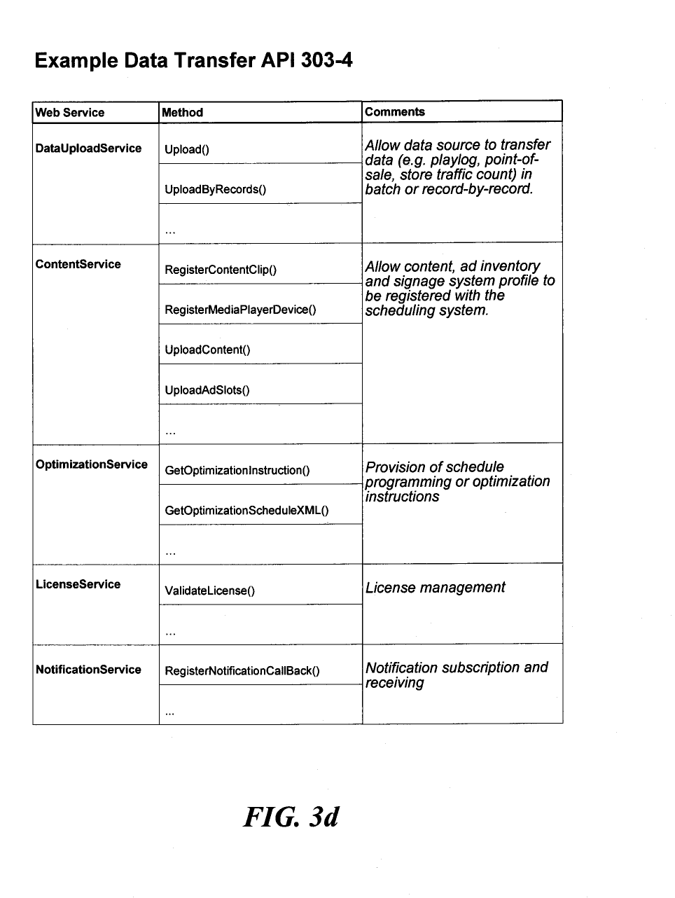

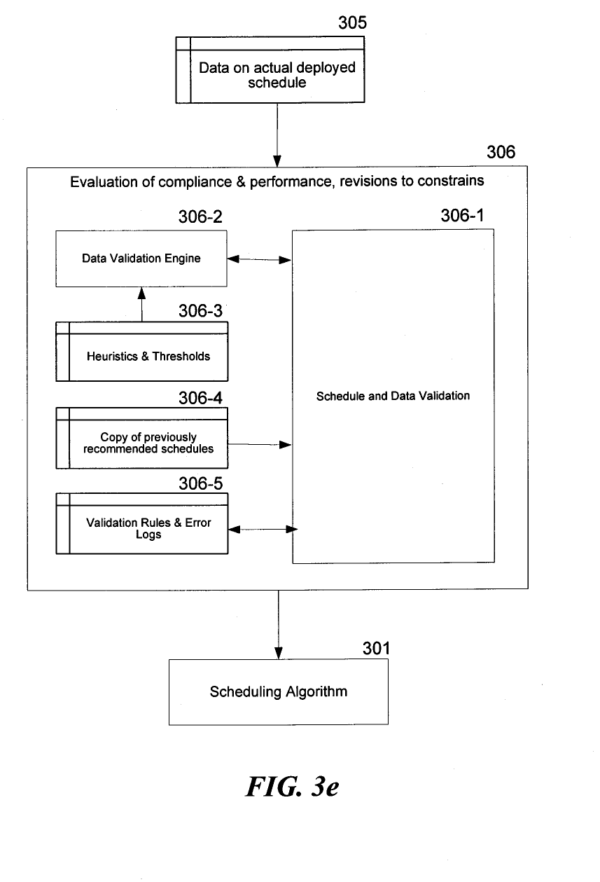

An embodiment is described in FIG. 3. In this embodiment, the scheduling and the actual management of the media devices are handled by separate computer systems. After the schedule 301 is determined (perhaps by the methods described in the previous section), communication of that schedule to the network of media devices 304 is handled by an intermediary component 303 (which could reside on either the scheduling side, or the media device network side, or both, or could be an independent system). Optionally, data 305 on the actual execution of the schedule and other supporting proof-of-performance data are collected back from the media device network after the schedule has been deployed. This data can be evaluated 306 and used to make modifications to the constraints and or objectives that go into the scheduling, in order to produce a new schedule. For example, it may be that a hardware outage prevented the campaign from being displayed in a certain set of stores for an entire day. The originally determined schedule had counted on being able to show the campaign during that day to satisfy a constraint on minimum time played per store per week. As a result, the rest of the schedule has to be readjusted in order to satisfy the constraints and/or better optimize the objective.

It is sometimes appropriate to omit the feedback loop of data 305. For example, motivations for doing so might be that there are few constraints to be concerned with, or the impact of breaking them is low, or the reliability of the network of media devices and compliance with scheduling instructions is very high.

Another way to use the feedback loop of data 305 is to use information learned previously to modify and improve a schedule. For example, if one location has proven to respond negatively to the campaign, and this result is quite stable and consistent in the audience behavior data, then it will be better to not show the campaign at that location. A modified version of the schedule can be created that makes this change; note that because of the constraints and objectives, that making such a change may require other changes in the schedule in order to maximize the objective under the constraints.

A variety of embodiments of the invention use different means to represent the actual scheduling data 302; they roughly fall into three categories described in this application:

The first category is commonly known as the playlist approach. This approach represents the recommended schedule by describing each piece of content and the content's corresponding play schedule. For example, assuming there are 5 content clips to be played in the network of media devices, namely a, b, c, d, and e, and each has a length of 15 seconds. The content sequence played in a playlist can be arranged ad hoc (e.g. playlist: ‘a b c a b c a b c a b d a b d c e d c d e . . . ’); or by the media device based on a fixed-length or variable length loop, consisting of a list of content clips to be played repeatedly as a loop (e.g. loop ‘a b c’ then loop ‘a b d’ then loop ‘c d e’). Both ad hoc and loop based schedules can be further described in a calendar fashion (e.g. from 1 pm to 4 pm play loop x, then transition to loop y) or by additional set of heuristics, constraints and rules to enrich the playlist's basic sequencing (e.g. campaign A must play at a date range, certain location, frequency, clip b must not play immediately after clip a, etc.).

The second category is to use a set of actual executable instructions known to the network of media devices to describe the schedule. FIG. 3a shows an example of some basic instructions for setting up or changing the schedule. Other implementations of the invention may include a larger set of instructions and permutations of factors. Use of the instruction approach can accomplish many common scenarios in setting up scheduling. As the sample instructions illustrate, it is possible to add, remove, replace a single campaign; and/or remove, replace, swap multiple campaigns based on ad slots schedule and constraints known to the scheduling system.

The third approach is a hybrid approach that combines the first and second approaches into one by either sequencing or inter-mixing these two different descriptions. FIG. 3b shows an example that combines both approaches. In its core representation, it has the flexibility of mixing both the scheduling information and the instructions. The mixed example 302-1 shows that playlist type and instructions type can be interlaced in an alternating pattern. Example 302-2 shows that playlists and instructions can be nested inside each other. Many other variations can be created from these simple concepts. For example, it is possible to have multiple nested blocks of playlist and instructions. The hybrid approach makes it possible to transmit a schedule or modification to a schedule (possibly a schedule or set of changes produced by the schedule generation component described earlier) to any network of media devices 304 that either understand playlists or can be driven by instructions.

FIG. 3c is an embodiment of system 303 that manages the schedule and data exchange between the network of media devices 304 and the scheduling algorithm generation system 301. In this embodiment, Data Transfer Services 303-1 is responsible for processing data collected from the network of media devices 303-6, which includes data that can be used to validate the proof of actual schedule played (e.g. content clip id, play time, play count, duration, media device down time, or other derived data) by the network of media devices 304. Data Transfer Services 303-1 can be implemented as a single component or a collection of independent components. Components in this embodiment can reside in a single machine or separate machines, in a single network of media devices or a federated network of media devices.

One of the services included in Data Transfer Services 303 is an application programming interface (API) 303-4 that can be invoked by a separate Data Transfer Agent 303-7. The API 303-4 provides a collection of programming interfaces that can be invoked by Data Transfer Agent 303-7 to access Data Transfer and Transformation 303-5, Licensing and Security Management 303-3 and Notification Subscription and Generation 303-2. The automation of the data transfer of scheduling data is accomplished when Data Transfer Agent 303-7 calls the API 303-4. A common implementation of 303-4 is known as XML Web Services, which uses the standard internet HTTP/XML/SOAP protocol for transporting data 303-6 and programming instructions 303-12. Each programming interface can be implemented as an independent Web Service residing on same or different physical computers. When API 303-4 is implemented as Web Services, Agent 303-7 will need to include a client proxy stub that is commonly provided by commercial development tool (e.g. Microsoft Visual Studios). 303-4 can also be implemented in other non-XML proprietary programming environments such as Microsoft Windows Programming and Sun's Java Programming. These environments often come with their native programming layer (e.g. Microsoft Windows API) without using HTTP and XML.

FIG. 3d shows an embodiment of the API to illustrate the nature of such programming interfaces that facilitates the exchange of data 303-6 and scheduling instructions 303-12. The exact services and methods will depend on the requirement and nature of the network and the scheduling system. A typical API 303-4 will include methods that support for upload data and information collected from the network of media devices 303-6 that includes but is not limited to customer response data (e.g. point-of-sale purchasing data, foot traffic, exposures, click stream from a kiosk or interactive device, mobile text message), play logs (e.g. play time, play count, duration), campaign description (e.g. id, name, dimension, display capability), ad inventory (e.g. ad slot availability, ad slot constraints), network topologies (e.g. single or federated network, single or multiple channels), network status and logs, etc. In addition, the API 303-4 may include methods that are used to notify the Data Transfer Agent 303-7 when a new recommended schedule 302 is available,

The Data Transfer and Transformation 303-5 can be useful in an embodiment using automated exchange of instructions and data between the scheduling component and the network of media devices, not only to provide a way to transfer data, but also a means to ensure the data collected from network of media devices 304 are syntactically meaningful and understandable to the scheduling system. When Data 303-6 does not follow standard formats that the scheduling system is designed to accommodate, a set of mapping rules can be used to maps the source data to the desired standard format. Many forms of the mapping rules can be used, one example is to use regular expression format which is well-known in the computer industry. If Data 303-6 is already collected in the standard XML format, Data Transfer and Transformation 303-5 simply transfers the data without any mapping or further modification of the collected data. The data transfer can happen as a single batch step or at a record-by-record basis where a record can be a fixed size or a variable-sized chunk of data from the source files, play logs, or databases, etc.

The Usage of the API 303-4 is optional in embodiments where the Data Transfer Agent 303-7 directly communicates with Data Transfer Services 303-1 using other non-programming methods to accomplish the automation of schedule transfer. One such method is to use Scheduled Tasks 303-11 to exchange data between Data Collector and Uploader 303-10 and Data Transfer and Transformation 303-5. The Scheduled Tasks 303-11 can be provided by the media devices system that hosts Data Transfer Services 303 or by any 3rd party data synchronization software. For example, a typical media device built on Microsoft Windows operating system will be able to leverage its Scheduler services for scheduling periodic tasks to initiate the data transfer. It is not uncommon for such embodiments to use an intermediate drop box (i.e. a file server location agreed between scheduling system 301 and the network of media devices 304) to store data by such scheduled transfer mechanism.

One of the biggest challenges facing the proposed scheduling systems is to understand accurately which campaigns are played, to determine if the recommended schedule has played according to the plan. The Data Collector and Uploader components 303-10 in this embodiment are designed to simplify the data gathering process that sometimes requires custom integration effort. One possible implementation may include agents that collect media device information, content data and play schedule either in a device-independent manner or as native adaptors that know how to talk to the media devices

Data Transfer Services 303-1 can also provide license and security management functions 303-3 to ensure schedule and data exchanged between the network of media devices and the scheduling system are properly protected and authorized in every transaction. License and Security Management 303-3 maintains a set of information that can include, but is not limited to, records of ID, license key, activation and expiration status of the invoking agents, etc.

The Usage of Notification Subscription and Generation 303-2 is also optional. When invoked, this service 303-2 allows Data Transfer Agent 303-7 to receive notifications when a schedule 302 is available. When such a service is utilized, the Data Transfer Agent 303-7 includes a Notification Listener 303-8 for listening and receiving the notification event 303-12 sent from Data Transfer Services 303-1. Once a notification is received by Data Transfer Agent 303-7, Schedule Optimizer 303-9 can be used to deploy the received data 303-12 into the Network of Media Devices 304.

Various embodiments allow content to be changed according to the recommended schedule change at the media device. This can often be accomplished by custom business logic provided by the network of media devices. In FIG. 3c, we employ the Schedule Optimizer 303-9 as a component for such purpose. Schedule Optimizer 303-9 holds the knowledge of the media devices' scheduling slots and can deploy the recommended schedule either as a whole or as an individual time slot. Based on the schedule description 302, the Schedule Optimizer 303-9 can based on pre-set constraints and the necessary instructions built by system described earlier to perform (a) replace, rename, swap, add or drop campaigns; (b) change order of campaigns; (c) change frequency of campaigns; (d) other media devices specific operations necessary to manage its playing schedule. Schedule Optimizer 303-9 can be implemented in a device-independent manner using a pre-established XML standard. It can also be implemented by a custom adapter according to a particular media device.

FIG. 3e that illustrates one embodiment of evaluation 306 from FIG. 3. Schedule and Data Validation 306 examines the accuracy of the data collected 305. The Data Validation Engine can detect duplication, omission or unknown campaigns, start time, duration, various error conditions (e.g. Media Device down time), etc. One embodiment of the invention is to use Fuzzy Logic techniques well known to those versed in the art in order to implement the Data Validation Engine. The Fuzzy Logic approach can be utilized to detect normal scheduling playback data vs. any of the error conditions listed above. The Data Validation Engine 306 retrieves a set of pre-set threshold values 306-3 that defines a modest percentage of errors to be considered harmless to the final scheduling recommendation. These pre-set thresholds can be determined and adjusted from on-going speed, accuracy and performance optimization. One way to identify an error condition is when the percentage of error entries in the collected data exceeds a pre-defined threshold. When such error condition occurs, validation errors can be recorded in a log or database tables 306-5 for subsequent process or human inspection. The non-compliance condition could then be turned into further validation rules 306-5 for enhanced automation and calibration of needed threshold of the deployed network of media devices 304.

After collected scheduling and play log data pass the initial data quality test, validation 306-1 compares the collected play data with the originally recommended schedule 306-4 to ensure that the scheduling recommendation was indeed conformed. To store the previously recommended schedule for bookkeeping purposed, copies of the old schedule can be stored as database records or XML files.

### Analysis of Results

The use of designed schedules like those created 102 in FIG. 1 provides opportunities for more sophisticated analysis approaches than described in U.S. patent application Ser. No. 11/619,506, entitled “MEASURING PERFORMANCE OF MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES,” which is incorporated herein in its entirety by reference. Changes in audience behavior due to a campaign are measured to utilize a variety of data (both with and without the campaign) to build a model that can predict the sales for a given time and place both with and without the campaign. The contribution of the campaign according to the model, as well as the difference between the actual behavior (with the campaign) and the predicted behavior (without the campaign), both provide insights as to the impact of the campaign. However, building an effective and reliable model depends upon adequate data without the campaign to effectively calibrate the model.

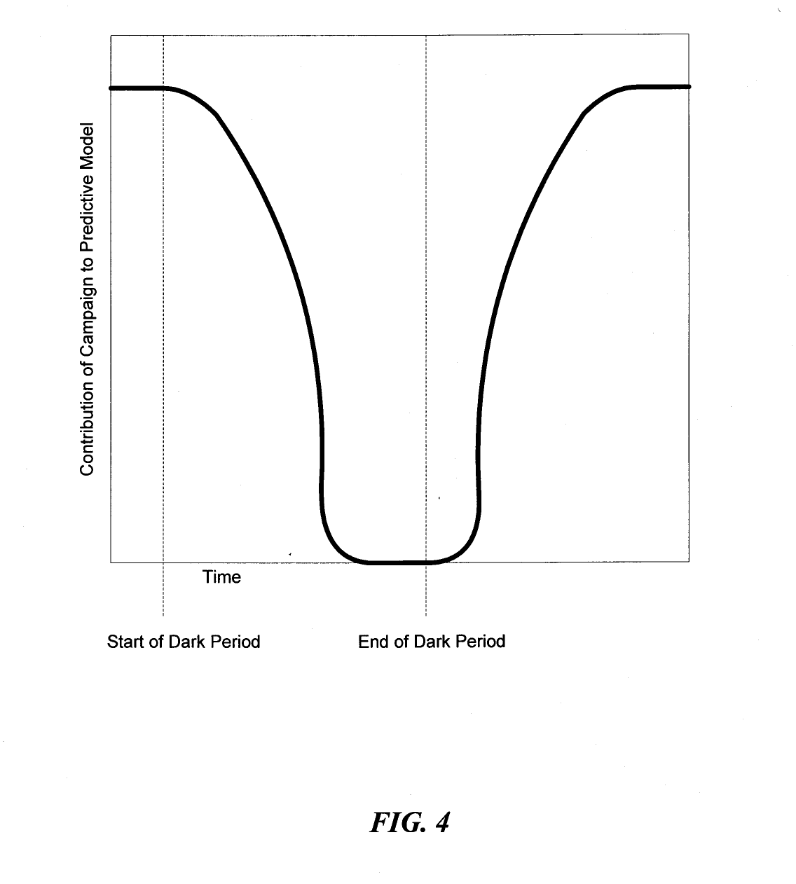

The behavior of the audience can vary based upon more than just whether or not the campaign was played recently. For example, let's say that the experimental design dictated 4 hour blocks of time without the campaign, spread randomly over stores and weeks; such a block of time without the campaign will be called Dark Time. During the start of the dark time, there will be customers who did see the campaign before engaging in the activity measured as audience behavior (e.g. purchasing a product advertised on a digital sign in a store). As we progress further into the dark time, this number of customers will decline until it nears or reaches zero. Then, once the dark time has ended, there will be customers engaging in the studied behavior who have not seen the campaign. This can be explicitly accounted for by using a function of the time around the dark period; see FIG. 4. As we get further into the dark period, the impact of the campaign becomes less and less, until we're to a point where we assume that the recent play of the campaign has no effect on any audience member. After the campaign comes back, there is a similar but gradual rise back to its normal level of contribution. Note that although the figure is symmetric, the actual function need not be; analysis of audience habits in the public place (amount of time spent there, how they move around) can help inform the nature of the function. This embodiment can be implemented as piecewise exponential, an exponential weighting scheme, as a cubic spline, or with numerous other functions. Here is an example of one possible embodiment:

f(t,r)=a exp(b min(0,c−(t−4))

Where a and b are scaling factors, c is a maximum lag time, t is the time of the audience behavior, and r is the most recent occurrence of the campaign. The transformation of the time and campaign information can then be used as an input to whatever predictive modeling approach is being used (e.g. neural networks, linear models, log-linear models, etc). If there is uncertainty or debate about the appropriate function (what the shape should be, best implementation), the alternatives can be evaluated on actual data to see whether they make an impact, and which one provides the closest agreement to the data. That is, the shape and behavior of the curve (e.g. the parameters a, b and c in the example above) could be inferred from audience behavior, utilizing a model fitting (e.g. fitting a statistical linear model, generalized additive model) or other analytical scheme (e.g. a neural network) to determine the parameters of the curve that best matches the data. Alternately, the functions could be estimated based upon detailed study of customer behavior—how long they spend in the store, how often they'll go past a particular sign, etc.

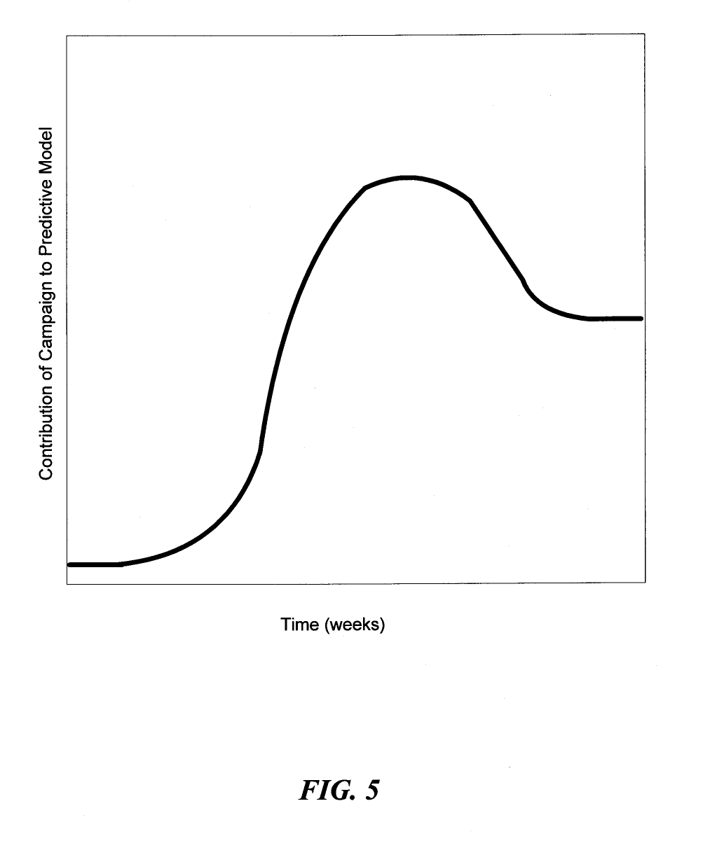

In another embodiment, there may be a need to account for long-term impact of the campaign. It may take numerous exposures to the campaign for it to have an impact upon a audience member; call this the build-up effect. Also, after the audience member has been exposed to the campaign many times, further exposure may have less effect (or even no effect, or a negative effect) on their behavior; call this the wear-out effect. These effects can also be incorporated into the predictive modeling scheme. FIG. 5 shows an example of a postulated function incorporated both build-up and wear-out, where it takes some weeks for the audience to have enough exposure to the campaign for it to affect their behavior. This highpoint quickly wanes, however, and the impact of the campaign drops substantially before leveling out. At the end, it still has an effect, but less than at its high point. As with the short-term dark period effect, these longer term build-up and wear out effects can be modeled with a piecewise exponential, a cubic spline, or a weighting scheme, among other possibilities. Actual data and studies of audience behavior can be used to evaluate possible shapes for these curves and determine which has the most support in actual practice. Finally, the function can be used to transform the campaign data (instead of or in addition to the raw data on campaign presence) in the predictive modeling.

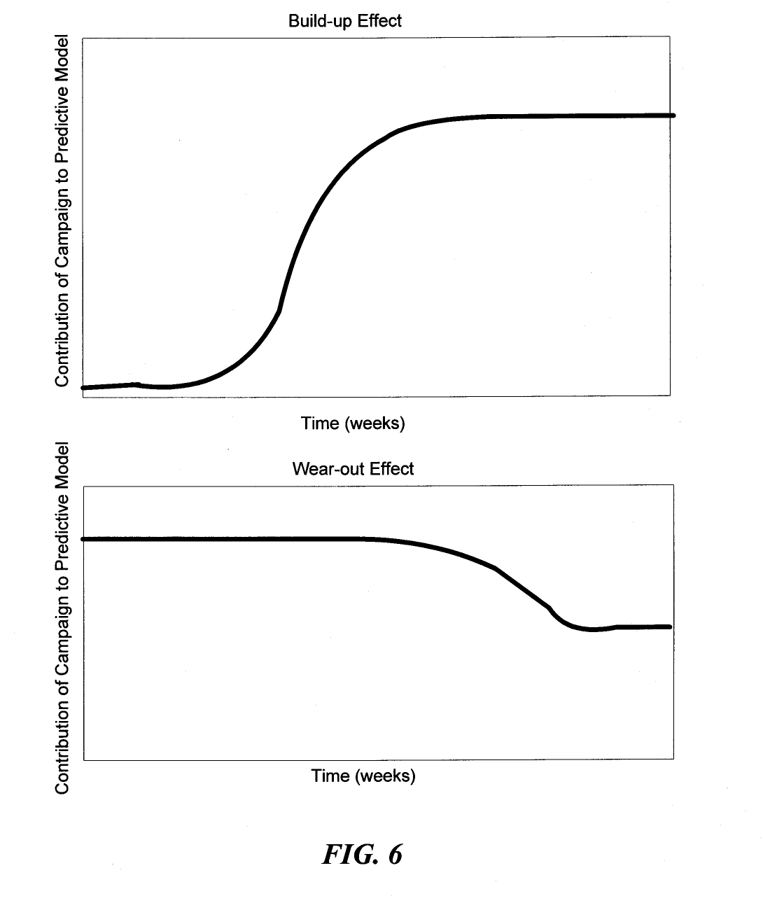

In the case of build-up and burn-out, they can also be implemented as separate functions (see FIG. 6), and one, the other, or both included in the predictive modeling stage as appropriate. An example of a build-up effect could be

a arctan(b(t−c))+d.

Where a and b are scaling factors, t is the time since the campaign started, c is the time when the growth in impact is the strongest, and d is an adjustment factor. An example of a burn-out effect could be

g−h arctan(i max(t−j,0)).

Other alternatives to dark periods can be applied, when the campaign is varied in the frequency with which it is played, the volume of an audio track, the brightness of a display, or other variable parameters. In the approach described for the dark period, it is the time since the campaign was last played which is transformed into a factor which will be used in modeling the impact of the campaign on audience behavior. This transformation could instead be a transformation applied to the volume or brightness or frequency during a time period, as described by an average, median, or range of values for that period.

This application describes inventions that can be used independently, or in conjunction with commonly assigned U.S. patent application Ser. Nos. 11/619,506 (entitled “MEASURING PERFORMANCE OF MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES”) and 60/493,263 (entitled “SYSTEM AND METHOD FOR DELIVERING AND OPTIMIZING MEDIA PROGRAMMING IN PUBLIC SPACES”), the disclosures of which are incorporated herein in their entireties by reference.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with data structures and computer-executable instructions that implement the approval system, which means a computer-readable medium that contains the data structures and the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in and used with various operating environments that include personal computers, server computers, hand-held or laptop devices, multiprocessor systems, microprocessor-based systems, programmable consumer electronics, digital cameras, network PCs, minicomputers, mainframe computers, computing environments that include any of the above systems or devices, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

In various embodiments, the system performs a method for producing a schedule for providing media in an media campaign via a network of out-of-home digital media devices. The method comprises selecting a first media content from a set of media content; receiving a business constraint relating to the selected first media content; receiving a statistical experimental constraint relating to the media campaign; identifying a time in a schedule during which the media content can be rendered in an out-of-home digital media device wherein the identifying includes satisfying the received business constraint and the statistical experimental constraint; and causing a digital media device to render the selected media content at the identified time.

In various embodiments, the system includes one or more computer-readable media collectively storing computer-executable instructions for causing a computing system to produce a schedule for providing media in an media campaign via a network of out-of-home digital media devices wherein the method comprises: selecting a first media content from a set of media content; receiving a statistical experimental constraint relating to the media campaign; identifying a time in a schedule during which the media content can be rendered in an out-of-home digital media device wherein the identifying includes satisfying the statistical experimental constraint; and causing a digital media device to render the selected media content at the identified time.

In various embodiments, the system comprise: storage component configured to store a set of media content; a component configured to receive a statistical experimental constraint; a component configured to receive a business constraint; a component configured to identify a time in a schedule during which the media content can be rendered in an out-of-home digital media device; and a component configured to cause a digital media device to render the selected media content at the identified time.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method performed by a computing system for producing a schedule for providing media in an media campaign via a network of out-of-home digital media devices, comprising:
selecting a first media content from a set of media content;
receiving a business constraint relating to the selected first media content;
receiving a statistical experimental constraint relating to the media campaign;
identifying a time in a schedule during which the media content can be rendered in an out-of-home digital media device wherein the identifying includes satisfying the received business constraint and the statistical experimental constraint; and
causing a digital media device to render the selected media content at the identified time.

2. The method of claim 1 further comprising measuring a response of viewers of the rendered media content.

3. The method of claim 2 further comprising scheduling the media content at a different time in the schedule based on the measured response.

4. The method of claim 1 wherein the identifying is based on a brute force technique.

5. The method of claim 1 wherein the identifying is based on an annealing technique.

6. The method of claim 1 wherein the identifying is based on a linear programming technique.

7. The method of claim 1 wherein the identifying is based on a stochastic simulation technique.

8. The method of claim 1 further comprising varying the media campaign.

9. The method of claim 8 wherein the varying includes not showing the selected media content.

10. The method of claim 8 wherein the varying includes showing a different media content than the selected media content at the identified time.

11. The method of claim 1 wherein the business constraint specifies that the selected first media content is not to be rendered within a specified time of a second media content.

12. The method of claim 1 wherein the business constraint specifies that the selected first media content is to be rendered at or near a specified time.

13. The method of claim 1 wherein the business constraint specifies that the selected first media content is to be rendered at or near a specified day.

14. The method of claim 1 wherein the business constraint specifies that the selected first media content is to be rendered at or near a specified date.

15. The method of claim 1 wherein the media campaign is an advertising campaign.

16. The method of claim 15 wherein the media content is an advertisement.

17. The method of claim 1 further comprising moving a media content already scheduled at the identified time in the schedule to a different time in the schedule.

18. The method of claim 1 wherein the business constraint is a minimum number of times that the selected media content is to be rendered.

19. The method of claim 1 wherein the business constraint is a minimum number of viewers of the selected media content.

20. A computer-readable medium storing computer-executable instructions for causing a computing system to produce a schedule for providing media in an media campaign via a network of out-of-home digital media devices, the method comprising:
selecting a first media content from a set of media content;
receiving a statistical experimental constraint relating to the media campaign;
identifying a time in a schedule during which the media content can be rendered in an out-of-home digital media device wherein the identifying includes satisfying the statistical experimental constraint; and
causing a digital media device to render the selected media content at the identified time.

21. The computer-readable medium of claim 20 wherein the method further comprises satisfying a business constraint relating to the selected first media content.

22. A system for producing a schedule for providing media in an media campaign via a network of out-of-home digital media devices, comprising
a storage component configured to store a set of media content;
a component configured to receive a statistical experimental constraint;
a component configured to receive a business constraint;
a component configured to identify a time in a schedule during which the media content can be rendered in an out-of-home digital media device; and
a component configured to cause a digital media device to render the selected media content at the identified time.
